(19) United States
(12) Patent Application Publication
(10) Pub. No.: US 2025/0190851 A1
(43) Pub. Date: Jun. 12, 2025

(54) SYSTEMS AND METHODS FOR OPTIMIZING HYPERPARAMETERS FOR MACHINE LEARNING MODELS

(71) Applicant: Microsoft Technology Licensing, LLC, Redmond, WA (US)

(72) Inventors: Agrin Aram HILMKIL, London (GB); Nick PAWLOWSKI, Cambridge (GB); Cheng ZHANG, Cambridge (GB); Wenbo GONG, Cambridge (GB); Maria DEFANTE, Woodinville, WA (US); Colleen TYLER, Redmond, WA (US); Lisa PARKS, Seattle, WA (US)

(21) Appl. No.: 18/534,543

(22) Filed: Dec. 8, 2023

(51) Int. Cl. G06N 20/00

(52) U.S. Cl. CPC G06N 20/00

(57) ABSTRACT

A combined hyperparameter and proxy model tuning method is described. The method involves multiple search iterations. In each search iteration, candidate hyperparameters are considered. An initial (‘seed’) hyperparameter is determined, and used to train one or more first proxy models on a target dataset. From the first proxy model(s), one or more first synthetic datasets are sampled. A first evaluation model is fitted to each first synthetic dataset, for each candidate hyperparameter, enabling each candidate hyperparameter to be scored. Based on the respective scores assigned to the candidate hyperparameters, a candidate hyperparameter is selected and used to train one or more second proxy models on the target dataset

### TECHNICAL FIELD

The present disclosure pertains to systems and methods for optimizing hyperparameters for machine learning models.

### BACKGROUND

Machine learning (ML) models allow computers to perform tasks such as learning patterns or making decisions without being explicitly programmed to do so. Instead, such tasks are learned (fully or partially) from training data via a structured training process. A training set comprises examples from which the model learns to improve its performance on a defined task. During training, one or more parameters of a machine learning model are tuned in a systematic fashion based on the training set, e.g., using a gradient-based approach (such gradient descent or gradient ascent) applied to the model parameter(s). Examples of such parameters include coefficients in of a linear regression model, weights in a neural network, or support vectors in a support vector machine. For supervised training, elements of the training set are labelled and the model generates outputs (referred to as predictions) comparable to the labels. A training loss function is defined that quantifies overall error between the model outputs and the labels, and the model parameters are tuned so as to reduce the overall error expressed in the training loss function. For example, in a gradient-based approach, gradients of the loss function with respect to the parameters are computed, and used to calculate updated parameters with the aim of reducing those gradients to zero or thereabouts. Parameter(s) of a machine learning model thus may be characterized as internal variables that the model learns from training data.

By contrast, hyperparameters are external configuration settings that are not learned from the training data. For example, hyperparameters may be set prior to the training process and fixed during training.

Incorrect or poorly tuned hyperparameters can lead to suboptimal model performance. Therefore, choosing appropriate hyperparameter values is an important aspect of machine learning model development to optimize model performance. Conventional hyperparameter selection may, for example, involve hand-tuning or random searching. Such approaches involve training and evaluating multiple models with different hyperparameters to compare model performance, which consumes significant computational resources.

### SUMMARY

A combined hyperparameter and proxy model tuning method is described by way of example. The method involves multiple search iterations. In each search iteration, candidate hyperparameters are considered. An initial (‘seed’) hyperparameter is determined, and used to train one or more first proxy models on a target dataset. From the first proxy model(s), one or more first synthetic datasets are sampled. A first evaluation model is fitted to each first synthetic dataset, for each candidate hyperparameter, enabling each candidate hyperparameter to be scored. Based on the respective scores assigned to the candidate hyperparameters, a candidate hyperparameter is selected and used to train one or more second proxy models on the target dataset. In embodiments, the method repeats, to consider a new round of candidate hyperparameters in a further search iteration, with further synthetic dataset(s) being sampled from the second proxy model to assess the new candidate hyperparameters in the same manner (but now with synthetic data sampled from the second proxy model). A new hyperparameter selected in this assessment may, in turn, be used to train one or more third proxy models on the target dataset.

### BRIEF DESCRIPTION OF FIGURES

Particular embodiments will now be described, by way of example only, with reference to the following schematic figures, in which:

FIG. 1 shows a schematic function block diagram of a model optimization system;

FIG. 2 shows a flowchart for a hyperparameter optimization method;

FIG. 3 shows a flow diagram for a hyperparameter optimisation algorithm;

FIG. 3A shows a flow diagram for an extended hyperparameter optimisation algorithm; and

FIG. 4 shows a schematic block diagram of a computer system.

### DETAILED DESCRIPTION

Hyperparameters pertaining to an ML model control overall model behaviour. Hyperparameters are important for tuning and optimizing the performance of a machine learning model. They are conventionally set by a machine learning engineer before the training process begins and remain constant during training. Examples of hyperparameters include a learning rate in gradient descent or gradient ascent, the number of hidden layers and neurons in a neural network, the depth of a decision tree, or the choice of a kernel in a support vector machine. As another example, a training loss function may comprise multiple terms that reward or penalize different aspects of model performance. Those terms may be weighted by one or more hyperparameter(s) in the form of relative weighting factors (to prioritize/deprioritize one aspect of performance relative to another) that are fixed in the training process.

Hyperparameters can be variables of the model itself (e.g. number of layers) or the training process (e.g. learning rate). Whilst parameters are tuned as part of the training process itself, hyperparameter tuning is a separate optimization task to enhance model performance. Usually this is not a choice, but rather a consequence of the fact that it is often not possible to take the gradient of the training loss function with respect to the hyperparameters. As noted, incorrect or poorly tuned hyperparameters can lead to suboptimal model performance. Therefore, choosing appropriate hyperparameter values is an important aspect of machine learning model development to achieve high model performance.

Hyperparameter tuning is a laborious process. To evaluate a hyperparameter set (that is, a hyperparameter or a combination of multiple hyperparameters), a model needs to be trained using those hyperparameter(s) and the trained model needs to be evaluated, as the model performance is used as in indication of the quality of the hyperparameter(s) used to train it. A training process performed to train at least one instance of a machine learning model with a given hyperparameter (referred to as a single ‘training run’ herein) coupled with an evaluation process to evaluate model performance (referred to as an ‘evaluation run’ herein) consumes significant computational resources. In some cases, a single run might involve training of multiple models, e.g. in a cross-validation approach. Hyperparameter optimization involves multiple training and evaluation runs with different hyperparameter sets. Conventional approaches typically involve a large element of trial and error, perhaps guided by human expert knowledge with ‘educated guesswork’.

Significant computational resources are wasted in performing training and evaluation runs for ‘bad’ choices of hyperparameters. More structured approaches to hyperparameter tuning have been explored, such as grid search, random search and Bayesian optimization. Nevertheless, such approaches have still been found to involve significant numbers of ‘wasted’ training and evaluation runs evaluating poor-quality hyperparameters.

In embodiments described herein, an improved hyperparameter optimization process is described, which is able to increase the quality of selected hyperparameter(s) over a given number of training and evaluation runs or, equivalently, reduce the number of training and evaluation runs required to achieve a given level of hyperparameter quality (where hyperparameter quality is assessed in terms of resulting trained model performance). Considering the significant computational resources consumed by a single training and evaluation run, an aim is to use computational resources of a training system more efficiently by reducing the number of ‘wasted’ training and evaluation runs performed in hyperparameter optimization.

Particular consideration is given to hyperparameter tuning for generative data synthesis models, also referred to as ‘proxy models’ herein. A proxy model supports generation of synthetic data of a specified type. A proxy model has parameters θ which are learned via training based on a target dataset D and hyperparameters v (note, in the following, references to parameters and hyperparameters in the plural also encompass a signal parameter or single hyperparameter). The following description may refer to a hyperparameter of a model for conciseness, noting that terminology extends to external variables of the process used to train the model (such as learning rate) which do not explicitly form part of the trained model but nevertheless influence the performance of the trained model.

Looking beyond the efficiency benefits, the described approach has the potential to achieve a better end result than is possible with conventional hyperparameter tuning since it enables an optimization for a target objective on synthetic proxies.

A proxy model trained on a target dataset {Xᵢ},=D where Xᵢ is an individual sample in the target dataset D, can be used to synthesize corresponding synthetic data samples \tilde{X}ᵢ. D is treated as having been drawn from some unknown distribution, denoted P, ({Xᵢ}=D˜P). An iterative hyperparameter optimization method is used to learn a parameterized distribution \tilde{P}_{θ}ⁱ(parameterized by θ) for each iteration i that gets gradually closer to P over multiple iterations. By assuming that Xᵢ are IID (Independent, Identically Distributed), each can be modelled and sampled independently. The parameters θ are learned though training in each iteration, and are influenced by the choice of hyperparameters, denoted v below.

Proxy models have many practical applications. For example, proxy models may be used to support causal methods, such as causal discovery methods or causal inference methods. Causal methods area broad class of methods concerning truly causal relationships exhibited in data (as opposed to mere correlations). Causal methods have broad applications in many fields of technology, some of which are considered in more detail below.

Causal discovery is primarily concerned with identifying and understanding an underlying causal structure within a given system. It involves the use of statistical techniques to analyze patterns in data and draw conclusions about potential cause-effect relationships. The goal may be to predict one or more properties of a dataset, such as causal properties, e.g., the form of a causal graph. A causal graph G is one way to capture information about a data generating process (DGP) associated with a dataset. For example, a DGP may be encoded probabilistically as a joint distribution over a causal graph and a dataset. A causal graph encodes assumptions about a DGP, with nodes representing variables in a system and interactions between different variables as directed edges between nodes. Other forms of causal model may be used to encode causal properties of datasets.

On the other hand, causal inference focuses on estimating the effect of a specific cause on an outcome. Once a causal model has been established (e.g., through causal discovery), causal inference seeks to quantify an impact of changing one variable on another variable. Causal inference may be used when considering potential interventions (treatments), where the goal is to understand what would happen to an outcome if a certain treatment action were performed.

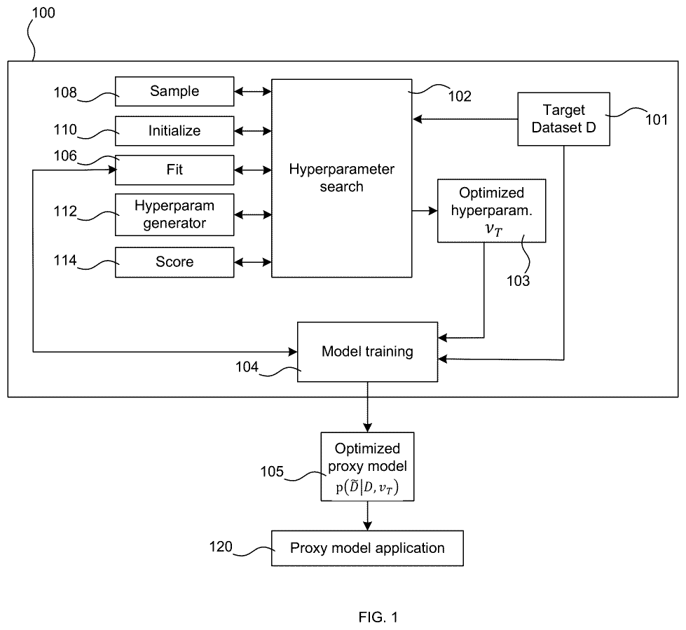

FIG. 1 shows a schematic function block diagram of a model optimization system 100. The model optimization system 100 is shown to comprise a hyperparameter optimization component 102 and a model training component 104. In brief, the hyperparameter optimization component 102 is configured to determine an optimized set of hyperparameters 103 (v_{T}), which are passed to the model training component 104. The model training component 104 is configured to train an optimized proxy model 105 on a target dataset 101 (D) using the optimized hyperparameters 103.

The hyperparameter optimization process also involves iterations of model training dependent on the target dataset 101, as described in more detail below. A fit function 106 is provided for this purpose. The fit function 106 is configured to receive as input a hyperparameter set and a dataset, and returns a trained model that has been trained on the inputted dataset using the inputted hyperparameter set. This function may also be referred to as fitting a model to the inputted dataset. Depending on the context in which the fit function 106 is used, the inputted dataset could be the target dataset 101 itself or a synthetic dataset generated using a proxy model (see below for further details). For use in generating the latter, a sampling function 108 is provided. The sampling function 108 receives as input a proxy model and returns one or more synthetic datasets sampled from the inputted proxy model.

An initialization function 110 is used to initialize the hyperparameter optimization process. The initialization function returns an initial set of hyperparameters v₀ used to train an initial proxy model (or models).

A hyperparameter generator 112 is configured to generate candidate hyperparameter sets for use in the optimization process. As described in more detail below, the hyperparameter optimization process is performed in multiple search iterations, with each search iteration involving a search over multiple hyperparameter sets. Within a given iteration, a search process such as random search, grid search or Bayesian search may be used.

The hyperparameter optimization process described herein incorporates hyperparameter search methods such as random, grid and Bayesian hyperparameter searching in a manner than is different to conventional hyperparameter optimization methodologies.

In brief, each search iteration starts from a current proxy model, and performs a search over multiple candidate hyperparameter sets (e.g. grid search, random search, Bayesian search etc.). Suitability of each of those candidates is evaluated using the current proxy model. At the end of a search iteration, the most promising candidate hyperparameter set is chosen. This, in turn, is used to train a new proxy model on the target dataset 101, and the next search iteration is performed in the same manner, but starting from the new proxy model (meaning the new proxy model is now used as a baseline to evaluate candidate hyperparameter suitability). The first iteration is performed using a first proxy model generated using initial hyperparameters returned by the initialization function 110. Subsequent search iterations are performed using the proxy model fitted to the target dataset 101 using the most promising hyperparameter set at the end of the previous search iteration. Thus, over multiple search iterations, not only are the hyperparameters iteratively improved, but the proxy model is also iteratively improved.

Evaluating the suitability of a candidate hyperparameter set uses the fit function 106 and a scoring function 114. Firstly, an evaluation model is trained, using the candidate hyperparameter set, on a synthetic dataset sampled from the current proxy model (using the sampling function 108). Then, the fitted evaluation model is evaluated using the scoring function 114. The scoring function 114 receives as input an evaluation model and a dataset, and returns a score that quantifies how well the evaluation model fits the dataset. One example of a suitable score is an F1 score for the evaluation model with respect to some known property (or properties) of the dataset. The F1 score is a machine learning evaluation metric that measures a model's accuracy (combining precision and recall). Other scores, such as a precision score or a recall score may be used. This score may be referred to as a matching score, as it quantifies an extent to which the evaluation model matches the dataset. To evaluate suitability of a candidate hyperparameter set, the scoring function 114 is applied to an evaluation model and the same synthetic dataset on which the evaluation model was trained using the candidate hyperparameter set under evaluation. In some embodiments, multiple synthetic datasets are samples from the current proxy model. In that case, an evaluation model may be fitted to each synthetic dataset, resulting in multiple evaluation models (trained using the same candidate hyperparameter set as each other), each of which is used to score the candidate hyperparameter set. Those scores are then aggregated to provide an overall matching score, which in turn is used to quantify the suitability of the candidate hyperparameter set.

Causal discovery applications are considered herein. In causal discovery, a true data generating process underlying a real dataset is generally unknown. However, a generative model (e.g. having a generative artificial neural network (ANN) architecture) can be trained on a dataset and used to predict a data generating process underlying the dataset. A known data generating process can also be used to synthesize a synthetic dataset.

Generative causal models, e.g., having generative neural network architectures are considered herein. Deep neural network architectures are considered. A class of generative causal model is considered with the ability to predict a causal property (e.g., a causal graph) for a dataset on which it is trained.

Reference is made to Geffner at al. “Deep End-to-end Causal Inference” (2022) arXiv: 2202.02195 (the DECI paper), which discloses a deep learning-based end-to-end causal inference framework named DECI. DECI is a single flow-based non-linear additive noise model (ANM) that takes in observational data and can perform causal, enabling causal quantities to be estimated using only observational data as input. The DECI model can also be used to perform causal inference.

In DECI, a causal graph G is described using a structural equation model (SEM). DECI takes a Bayesian approach to causal discovery. Given a training dataset x=(x¹, . . . , x^{N}) of d-dimensional datapoints xⁿ with an unknown causal graph G, a variational distribution, parameterized by first parameters ϕ over the unknown causal graph G is learned. The variational distribution, denoted q_{ϕ}(G), approximates a posterior distribution, dependent on second parameters θ, of the causal graph G given the training dataset, p_{θ}(G|x). Functional relationships are modelled using a predetermined noise distribution p_{z} and a set of feedforward, fully-connected artificial neural networks (also known as multilayer perceptrons or MLPs) whose operation is described by the following equations:

$${p}_{θ} ( {x}^{n} \vert G ) = {\prod }_{i = 1}^{d} {p}_{{z}_{i}} ( {g}_{G} ( x ; θ ) ) ,$$

$$z = {g}_{G} ( x ; θ ) = x - {f}_{G} ( x ; θ ) ,$$

$${f}_{i} ( x ) = {ξ}_{i} ( {\sum }_{i = 1}^{d} {G}_{j , i} {l}_{i} ( {x}_{j} ) ) ,$$

where each ζᵢ and lᵢ is an MLP with weights shared across nodes. The second parameters θ comprise the (shared) weights of the neural networks ζᵢ and lᵢ.

The first and second parameters ϕ, θ are learned in training for the given training set x by maximizing an evidence lower bound (ELBO) thereof, denoted ELBO (θ, ϕ). Adam optimization is used. In one example, implementation, the fit function 106, when applied to a target dataset D of the form=(x¹, . . . , x^{N}), trains a DECI model in this manner, using a given set of hyperparameters v. The model training component 104 may operate in the same way, using optimized hyperparameters. Different trained models may be obtained with the same hyperparameters, for example, with different random initializations of the first and second parameters θ, ϕ. In this context, hyperparameters to be optimized may, for example, include one of more of those listed in Appendix B.2 of the DECI paper, such as a scalar λₛ used to define a causal graph prior (see Equation 6 of the DECI paper), a temperature of a Gumbel softmax method used for ELBO gradient estimation, the number of layers and/or neurons of neural networks ζᵢ and lᵢ etc. It will be appreciated this not an exhaustive list of hyperparameters and other implementations are applied to additional or alternative hyperparameter(s).

Once trained, synthetic data is sampled by sampling noise variables z from the predetermined noise distribution, z˜p_{z}, and sampling a causal graph G from the learned variational distribution, G˜q_{ϕ}(G). Synthetic data samples are then obtained by solving for x the final two equations listed above (corresponding to equations (1) and (8) in the DECI paper) using the sampled graph G˜q_{ϕ}(G) and the sampled noise variables z˜p_{z}. In one example implementation, the sampling function 108 operates in this manner, utilizing the functional relationships described in equations (7) and (8) of the DECI paper. The data sampling procedure can be summarized as: sample graph, sample noise, and forward propagate through the graph with the functional relationships to sample data.

In one example causal discovery application, the proxy and evaluation models take the form of casual discovery models (such as DECI models) trained on real and synthetic dataset respectively, with the model training component 104, the fit function 106 and the sampling function 108 configured as described above. A dataset (D) having an unknown causal graph (such as a real dataset) is received. Some initial hyperparameter set v₀ is chosen. A first proxy model (model₁) is fitted to D though training based on v₀. Once trained, model₁ provides a first prediction of the unknown causal graph (denoted G₁) for the target dataset D on which it is trained. A first synthetic dataset (\hat{D}₁) is, in turn, synthesised using G₁. A first evaluation model (e-model₁) is then fitted to \hat{D}₁ based on a first hyperparameter set v₁. The first evaluation model, e-model₁, provides a predicted causal graph for synthetic dataset \hat{D}₁, denoted H₁, in the same way that proxy model₁ provides the predicted causal graphG₁ for target dataset D. Note that, whilst G₁ is only a first estimate of the (unknown) causal graph for the target dataset D, it is by definition the true causal graph for synthetic dataset \hat{D}₁. Therefore, it is possible to score e-model₁ by comparing G₁ (the true causal graph underlying \hat{D}₁) with H₁ (e-model₁'s prediction of G₁). A hyperparameter search is used to evaluate different combinations of hyperparameters v₁ in this manner (training and scoring different evaluation models with different v₁), enabling the most promising v₁ to be selected. Having selected the most promising v₁, the method repeats iteratively, training a second proxy model, model₂, on the target dataset D using the selected v₁, (yielding a second causal graph prediction for D, G₂), synthesising a second synthetic dataset \hat{D}₂ using G₂, fitting a second evaluation model, e-model₂, to \hat{D}₂ through training based on a second hyperparameter set v₂ (yielding a causal graph prediction for \hat{D}₂, denoted H₂), and scoring e-model₂ based on a comparison of G₂ (the true causal graph underling \hat{D}₂) with H₂ (e-model₂'s prediction of G₂). This is repeated over T iterations, eventually yielding optimized hyperparameters v_{T} and optimized proxy model_{T}.

With DECI, the described approach can be extended to causal inference, such as average treatment effect (ATE) estimation, by incorporating additional samples from an interventional distribution in the manner described in the DECI paper.

In summary, a generative model is learned that is able to predict the causal graph of the target dataset. This causal graph is used to generate data. However, finding this causal graph (on the real target dataset) is the ultimate objective. The method assumes that the proxy is close to the real dataset, enabling that objective to be approximated on the synthetic datasets.

In each iteration t, Gₜ and Hₜ may each take the form of causal graph adjacency matrix (meaning a matrix representation of a finite causal graph). In such embodiments, a matching score (e.g., F1 score) may computed between the computational graph adjacency matrices Gₜ and Hₜ (that is, between the true adjacency matrix of the proxy, and the adjacency matrix predicted by the evaluation model).

Similar principles can be applied more broadly, where a synthetic data set is generated based on a known property or properties, where a proxy model (e.g. generative neural network) trained on a target dataset provides a predicted property (or properties) of the dataset that can in turn be used to synthesise a synthetic dataset. In this case, an evaluation model (e.g. generative neural network) trained on the synthetic dataset provides a predicted property (or properties), which can be compared with the true property (or properties) in a similar manner. This approach is particularly useful in circumstances where the property (or properties) of the target dataset are unknown.

The terms “predicted target dataset property” and “predicted synthetic dataset property” are used to refer to predictions by a proxy model (trained on a target dataset) and an evaluation model (trained on a synthetic dataset) respectively.

In a validation use-case, several different causal discovery models may be validated. This can be achieved by tuning them to the proxy dataset and evaluating their performance on the known graph of the synthetic dataset.

An evaluation model is fitted to a synthetic dataset in the same way a proxy model is fitted to the target dataset 101, and has the same form as a proxy model. An evaluation model may the therefore be generated in the same manner as a proxy model, using the fit function 106 applied to a candidate hyperparameter set and a synthetic dataset sampled from a proxy model (in place of the target dataset 101). The ‘proxy/evaluation’ terminology is used purely for ease of understanding, as it reflects the different roles of these models in the hyperparameter optimization process.

The optimized proxy model 105 obtained at the end of the process may also be generated in the same manner, using the fit function 106 applied to the target dataset D and the optimized hyperparameter set 103 obtained in the hyperparameter optimization process. This proxy model 105 is optimized in the sense that it has been trained using the optimized hyperparameters 103. Note, the term optimized does not necessarily imply ‘fully optimal’. Rather, it refers to hyperparameters than have been improved by way of the iterative optimization process. In an extended use case, the generative model (e.g., the final, optimized model) can be used to tune another target algorithm, such as a non-generative machine learning model.

A proxy model application 120 is shown in FIG. 1 receiving the optimized proxy model 105 as input.

Proxy models of the kind described above have many practical applications. As mentioned, one broad class of application pertains to causal methods.

As discussed, causal inference is a fundamental problem with wide ranging real-world applications in fields such as manufacturing, engineering and medicine. Causal inference involves estimating a treatment effect of actions on a system (such as interventions or decisions affecting the system). This is particularly important for real-world decision makers, not only to measuring the effect of actions, but also to pick the best action that is the most effective.

One such application is causal method selection or validation. In this case, a proxy model trained on a causal dataset can be used to validate a casual method, such as a causal inference method. In this context, improvements to the proxy model have consequent improvements in the casual method evaluation, which in turn increases the probability of selecting the most appropriate causal method for a given application context.

For example, proxy models may be used to generate synthetic datasets exhibiting causal relationships, which in turn may be used to evaluate different causal methods, e.g., to select an appropriate causal method from multiple candidate causal methods for use a given practical application. High-quality synthetic causal data is highly desirable in this context because, in practice, it is challenging or impossible to obtain real data with ground truth that can be used for cross-validation between candidate causal methods. By contrast, for synthetic data, such ground truth can be readily generated (or may be intrinsic to the process of generating the synthetic data). For the validation case, different causal discovery models can be evaluated tuning them to the proxy dataset and evaluating their performance on the known graph of the synthetic dataset.

Causal inference methods may be used to estimate a treatment effect of an action on some real-world system. For example, a causal graph (or other causal properties) predicted by a proxy model (optimized using the described methods) may be used in a causal inference method. A ‘treatment’ refers to an action performed on a physical or logical system. Testing may be performed on a number of ‘units’ to estimate effectiveness of a given treatment, where a unit refers to a physical system in a configuration that is characterized by one or more measurable quantities (referred to as ‘covariates’). Different units may be different physical systems, or the same physical system but in different configurations characterized by different (sets of) covariates. Treatment effectiveness is evaluated in terms of a measured ‘outcome’ (such as resource consumption). Outcomes are measured in respect of units where treatment is varied across the units. For example, in one a ‘binary’ treatment set up, a first subset of units (the ‘treatment group’) receives a given treatment, whilst a second subset of units (the ‘control group’) receives no treatment, and outcomes are measured for both). More generally, units may be separated into any number of test groups, with treatment varied between the test groups.

For example, in the manufacturing industry, causal inference can help quantitatively identify the impact of different factors that affect product quality, production efficiency, and machinery performance in manufacturing processes. By understanding causal relationships between these factors, manufacturers can perform industrial machine actions (such as tuning, adapting, modifying or replacing an industrial machine) to optimize their processes, reduce waste, and improve overall efficiency. As another example, in the field of engineering, causal inference can be used for root cause analysis and identify underlying causes of faults and malfunctions in machines or electronic systems such as vehicles or unmanned drones (e.g. aircraft systems). By analyzing data from sensors, maintenance records, and incident reports, causal inference methods can help determine which factors are responsible for observed issues and guide targeted maintenance and repair actions. In genome-wide association studies (GWAS), causal inference may be used, for example, to associate between genetic variants and a trait or disease, accounting for potential confounding factors, which in turn may allow therapeutic treatments to be developed or refined. As another example, different energy management actions may be evaluated in a manufacturing or engineering context, or more generally in respect of some energy-consuming system, to estimate their effectiveness in terms of energy saving, as a way to reduce energy consumption of the energy-consuming system. A similar approach may be used to evaluate effectiveness of an action on a resource-consuming physical system with respect to any measurable resource. Causal inference may interface with the real-world in term of both its inputs and its outputs/effects. For example, multiple candidate actions may be evaluated via causal inference, in order to select an action (or subset of actions) of highest estimated effectiveness, and perform the selected action on a physical system(s) resulting in a tangible, real-world outcome. Input may take the form of measurable physical quantities such as energy, material properties, processing, usage of memory/storage resources in a computer system, therapeutic effect etc. Such quantities may, for example, be measured directly using a sensor system or estimated from measurements of another physical quantity or quantities. Casual analysis may be performed in a cybersecurity context, e.g. to identify causes of cyberthreats or potential cyberthreats, and mitigate such causes though appropriate security mitigation actions.

The hyperparameter turning method is especially useful for any type of generative process where tuning hyperparameters is hard, especially where formulating a true target is hard. Other applications of proxy models beyond causal methods are envisaged.

For example, in industrial processes where certain quantities are hard to measure, a model may be formulated for this process and its hyperparameters iteratively optimize via proxy tuning. Other examples include scenarios behaviour of any type of agent is modelled. e.g. humans driving in traffic (applicable to autonomous driving), or players in a game. With the present techniques, it is possible to learn models that gradually learn to reproduce their behaviour better, and since internal characteristics of the models are accessible, it is feasible to exactly measure e.g. the likelihood of a certain action.

Other applications include, for example, hyperparameter tuning for generative image models, generative audio models or language models (such as large language models), or other content models, particularly synthesis based on inferred properties of images, audio, text and/or other content etc.

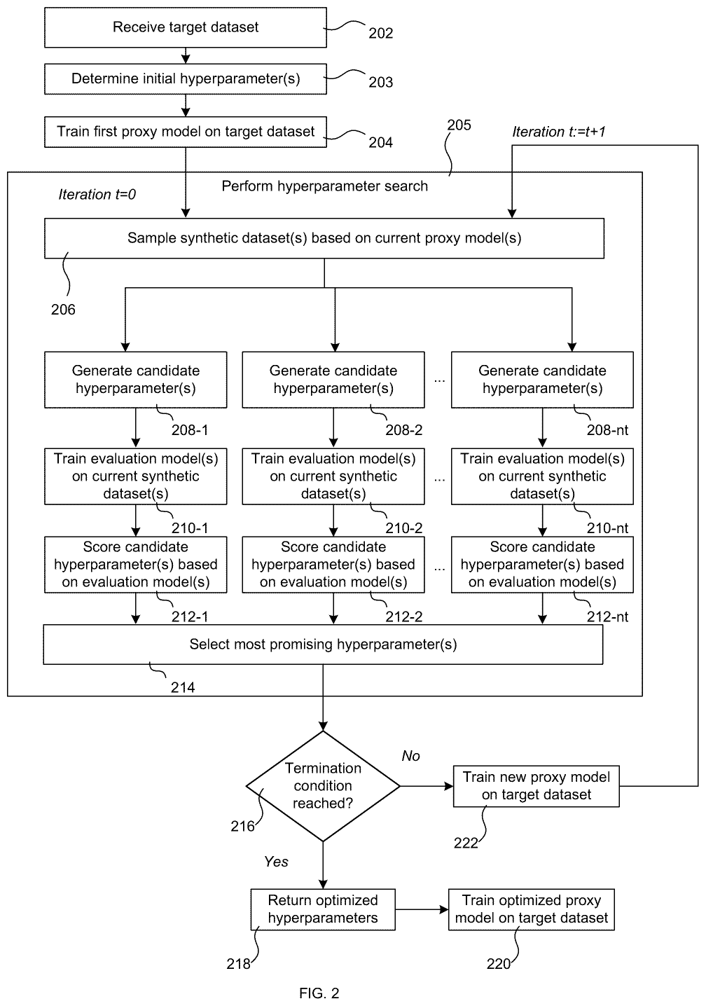

FIG. 2 shows a flowchart for a hyperparameter optimization method. The method of FIG. 2 is performed by the model optimization system 100 of FIG. 1. Therefore, elements of FIG. 1 are referred to in the description of FIG. 2.

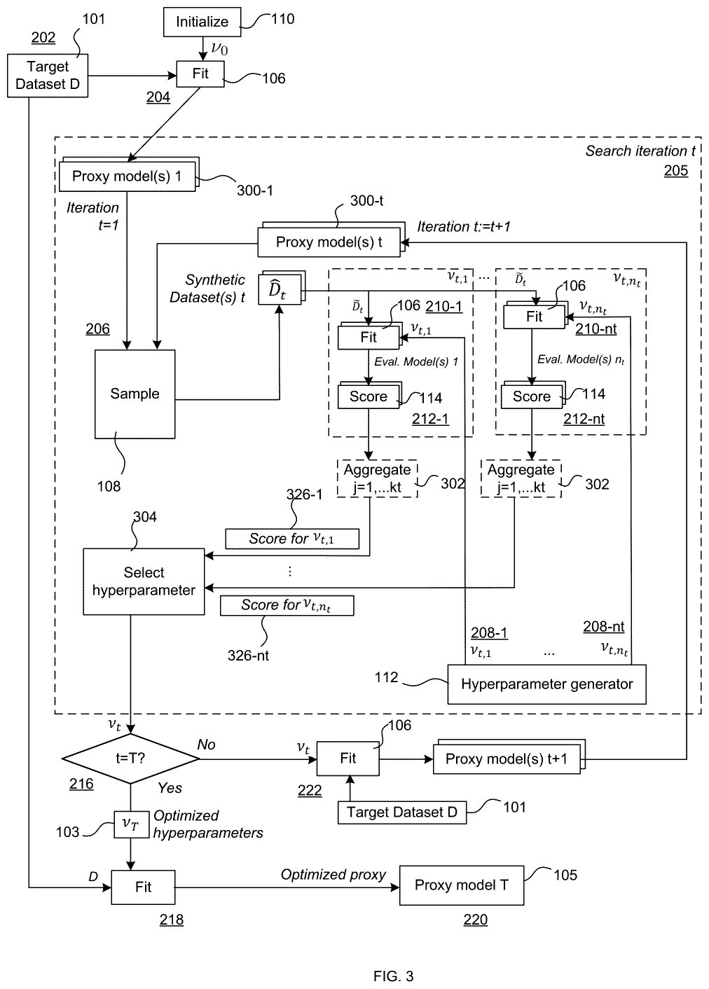

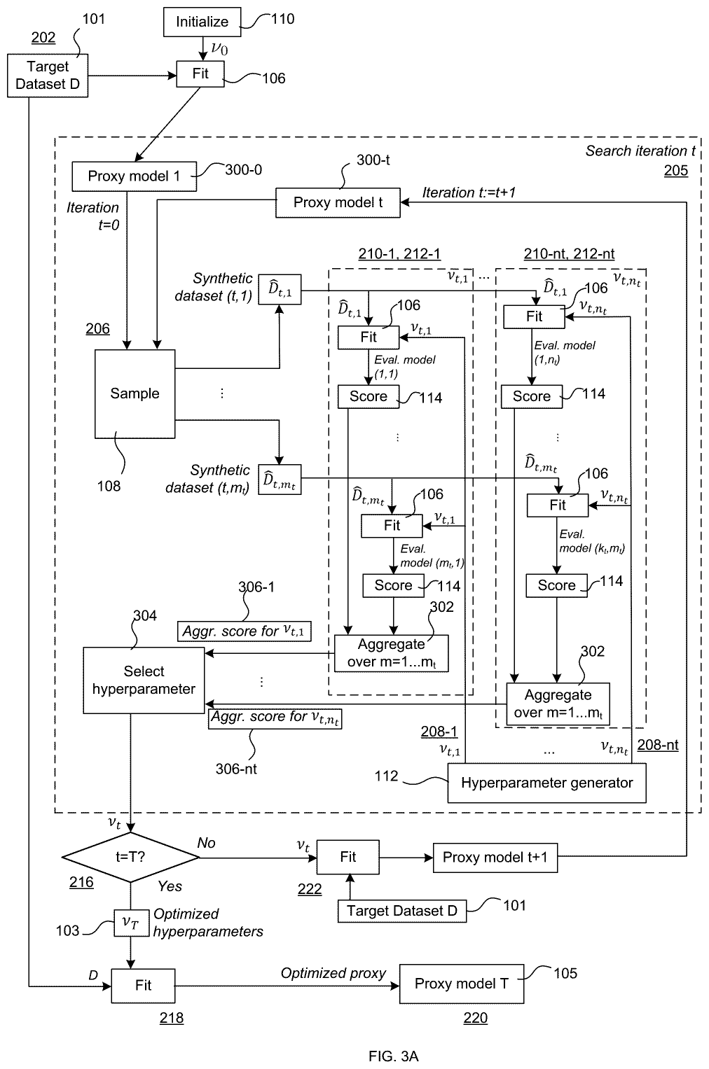

FIG. 3 shows a first example algorithm implementation of the method of FIG. 2 using the functions of FIG. 1.

FIG. 3A shows a second example algorithm implementation of the method of FIG. 2.

FIGS. 3 and 3A use the same reference numerals as FIG. 2 where appropriate to denote correspondence with steps of FIG. 2. FIGS. 2, 3 and 3A are described together, noting that FIGS. 3 and 3A are merely two example implementation of the method of FIG. 2. Reference is made to specifics of FIGS. 3 and 3A where useful.

At step 202, the target dataset 101 (D) is received.

At step 203, the initialization function 110 is used to generate an initial set of hyperparameters v₀. Several example initialization processes are described below.

At step 204, a first proxy model (model₁) is trained on the target dataset D using the initial hyperparameters v₀.

FIG. 3 shows a first proxy model generated at step 204 denoted by reference sign 300-1. In a first example extension of the method, multiple first proxy models are trained on the target dataset D using the hyperparameters v₀ at step 204, each based on a randomly-generated seed. The randomly generated seed provides variation in the training processes, meaning that different proxy models are obtained even though they are trained on the same dataset D with the same hyperparameters. In the description below, the notation model₁ⱼ is used to denote the jth first proxy model (trained with a jth random seed) trained at step 204.

Reference numeral 205 is used to denote a hyperparameter search process, which is repeated multiple times in an iterative manner, using iteratively updated proxy models. Each instance of the hyperparameter search process is referred to as a search iteration. In the following description, an index t is used to denote a current search iteration, with t=1, . . . , T. Reference is made to a current proxy model (modelₜ), and for the first search iteration (t=1, which is step 204), this is the first proxy model 300-1 generated at step 204 (model₁).

In the first extension, multiple proxy models are trained at each iteration t, with different random seeds, and in that case the notation modelₜⱼ is used to denote the jth proxy model in the tth iteration.

The hyperparameter search process 205 is performed as follows.

At step 206, a synthetic dataset \hat{D}ₜ is sampled from the current proxy model (modelₜ) using the sampling function 108 applied to the current proxy model.

In the first extension (multiple proxies), a synthetic dataset \hat{D}ₜⱼ is sampled from each current proxy model modelₜⱼ with j=1, . . . , kₜ, resulting in kₜ synthetic datasets sampled from the kₜ current proxy models.

In a second extension visualized in FIG. 3A, multiple synthetic datasets {\hat{D}_{t,m}} are sampled from a current proxy model (modelₜ). In the description below and in FIG. 3A, mₜ denotes the number of synthetic datasets sampled from modelₜ in the t^{th} search iteration, which may be the same or different between different search steps. Note, in other implementations, a single dataset might be sampled in a given search step, in which case mₜ=1. The first and second extensions may be combined, with multiple proxy models trained in each iteration, and multiple synthetic datasets sampled from each proxy.

The notation \hat{D}_{t,m} (used in FIG. 3A) denotes an mth dataset sampled from modelₜ in search step t, with m=1, . . . , mₜ.

In search iteration t, nₜ candidate hyperparameter sets are considered. The number of candidate hyperparameter sets nₜ may or may not vary between different search iterations depending on the embodiments (that is, nₜ may or may not be constant). The nₜ candidate hyperparameter sets are generated in steps 208-1, . . . , 208-nt in FIG. 2. As explained below, in general, these steps may be performed sequentially or in parallel, using an appropriate hyperparameter search method, examples of which are described below.

The notation v_{t,n} (used in FIGS. 3 and 3A) denotes the nth candidate hyperparameter set considered in search iteration t, with n=1, . . . , nₜ.

For each of the nₜ candidate hyperparameter sets, an evaluation model is trained on the synthetic dataset \hat{D}ₜ sampled in step 206 (steps 210-1, . . . , 210-nt). That is, in step 201-1, an evaluation model is trained on \hat{D}ₜ using v_{t,1}; in step 201-2, an evaluation model is trained on \hat{D}ₜ using v_{t,2} etc. In the simplest case of a single proxy modelₜ and single synthetic dataset \hat{D}ₜ, steps 210-1, . . . , 210-nt result in nₜ evaluation models in total (one for each candidate hyperparameter set).

In the first extension (multiple proxies), kₜ synthetic datasets have been sampled from the kₜ current proxy models, and an evaluation model is fitted to each of these for each set of candidate hyperparameters v_{t,n}, resulting in nₜ×kₜ evaluation models.

In the second extension of FIG. 3A (multiple synthetic datasets per proxy), an evaluation model is trained on each of the mₜ synthetic datasets for each v_{t,n}. Therefore, nₜ×mₜ evaluation models are trained in total in search iteration t in this case.

In FIG. 3A, index (m, n) is used to denote the evaluation model trained on the mth synthetic dataset, \hat{D}_{t,m}, using the nth candidate hyperparameter set, v_{t,n}.

Each evaluation model (1,1), . . . (k_{t,1}), . . . , (1,nₜ), . . . (kₜ, nₜ) is trained by applying the fit function 106 to the applicable synthetic dataset and candidate hyperparameter. So, evaluation models (1,1), . . . , (1,nₜ) are each trained on synthetic dataset \hat{D}_{t,1}, using hyperparameter sets v_{t,1}, . . . , v_{t,n}_{ₜ}, respectively; evaluation models (mₜ, 1), . . . (mₜ, nₜ) are each trained on synthetic dataset \hat{D}_{t,m}_{ₜ}, using hyperparameter sets v_{t,1}, . . . , v_{t,n}_{ₜ}, respectively (and so on).

As noted, the first and second extensions may be combined, resulting in nₜ×kₜ×mₜ evaluation models.

For each evaluation model, the scoring function 114 is evaluated for the applicable candidate hyperparameter set, at steps 212-1, . . . , 212-nt respectively.

Thus at step 212-1, the scoring function 114 is evaluated for the evaluation model trained in step 210-1 using the candidate hyperparameter set generated at step 208-1, resulting in a matching score. With multiple evaluation models, resulting in multiple scores, those scores are aggregated using an aggregation function 302 (e.g. summation function) to provide an overall score for the candidate hyperparameter set generated in step 208-1 (and so on).

As depicted in FIG. 3, in the first extension (multiple proxies), kₜ evaluation models are obtained for each v_{t,n} and scored, resulting in kₜ matching scores, which are aggregated to provide an overall (aggregate) score for each kₜ (aggregating over the multiple proxies) The outcome is overall scores 326-1, . . . , 326-nt for candidate hyper parameter sets v_{t,1}, . . . , v_{t,n}, respectively.

In the second extension of FIG. 3A (multiple synthetic datasets per proxy), for evaluation models (1,1), . . . , (k_{t,1}) (trained on synthetic datasets \tilde{D}_{t,1}, . . . , \tilde{D}_{t,1} respectively, all using candidate hyperparameter set v_{t,1}), the scoring function 114 is applied to each of those evaluation models (1,1), . . . , (kₜ,1) and the synthetic dataset \tilde{D}_{t,1}, . . . , \tilde{D}_{t,1} used to train it to compute individual matching scores against the synthetic dataset for the candidate hyperparameter set v_{t,1}; those individual scores are then aggregated (e.g. summed) to produce an overall (aggregate) score 306-1 for v_{t,1}, and so on, resulting in aggregate scores 306-1, . . . , 306-nt for candidate hyper parameter sets v_{t,1}, . . . , v_{t,n}_{ₜ}, respectively. The aggregate function 302 is applied to the individual matching scores for each candidate hyperparameter set, resulting in the overall score 306-1, . . . , 306-nt for each of the nₜ candidate hyperparameter sets.

Steps 208-1, 210-1 and 212-1 together constitute a first training and evaluation run. Steps 208-2, 210-2 and 212-2 constitute a second training run, and so on. In search iteration t, nₜ training and evaluation runs are thus performed in total, to generate and score nₜ candidate hyperparameter sets.

The hyperparameter generator 112 generates the candidate hyperparameters at steps 208-1, . . . , 208-n, as depicted in FIGS. 3 and 3A. This may be achieved in various ways, using one of several hyperparameter search processes.

In one embodiment, a random search is performed. In a random search, hyperparameters are selected randomly, within some defined criteria (for example, they may be randomly sampled from a probability distribution defined over hyperparameter space).

In another embodiments, a grid search approach, is used, in which the candidate hyperparameter sets are typically chosen to be spaced uniformly apart in hyperparameter space (in a grid-line fashion).

For random and grid searches, there is no inter-dependence between selected hyperparameters. Therefore, in this case, steps 208-1, . . . , 208-nt can be performed in parallel, or sequentially in any order with respect to each other. The same is true of steps 210-1, . . . , 210-nt and steps 212-1, . . . , 212-nt.

In another embodiment, a Bayesian search approach, is used. In essence, a Bayesian search strategy applies Bayesian optimization to the hyperparameter search problem. A Bayesian approach uses a posterior of the previous search iteration as the prior in the next. One or more initial hyperparameter set(s) are chosen (e.g., randomly), and used to perform initial training and evaluation run(s). The resulting trained models are used to evaluate the initial hyper parameter set(s). Those results are then used to build a performance prediction model, which in turn can be used to select a subsequent hyperparameter set (e.g., which is predicted to yield best model performance according to the Bayesian prediction model). A further training run is then performed using the selected hyperparameter set(s), again resulting in a trained model that is used to evaluate the selected hyperparameter set. That result is, in turn, used to update the performance prediction model, which in turn is used to select the next hyperparameter set and so on. In this manner, earlier training runs based on previously-selected hyperparameters are used to guide the selection of hyperparameters for later runs. The idea is that earlier runs can indicate potentially promising area(s) of the hyperparameter space, with the selection of hyperparameters for subsequent training runs guide being guided towards those promising region(s) by the incrementally updated performance prediction model.

In a Bayesian search embodiment, the hyperparameter generation at step 208-2 is dependent on the evaluation of the previous hyperparameters at step 212-1, with an intervening step (not depicted) of training a performance prediction model (and so on). Thus, in such embodiments, step 208-2 is dependent on step 212-1 and so on.

Random search has had practical advantages, as it enables a larger number of trials to be run in parallel. However, a Bayesian search may yield better performance of the hyperparameter optimization method.

At step 214, one of the nₜ candidate hyperparameter sets is selected based on the overall scores computed steps 212-1, . . . , 212-nt. In one embodiment, the highest scoring candidate hyperparameter set is be selected. In another embodiment, an acceptance condition is applied, as described in further detail below. The hyperparameter set selected in step 214 of search iteration t is denoted vₜ. Search iteration t terminates at this point.

FIGS. 3 and 3A shows a hyperparameter selection function 304 used to select one of the nₜ candidate hyperparameter sets based on their overall score 306-1, . . . , 306-nt. In the embodiment that simply selects the highest score, this is an ‘argmax’ function applied to the set of nₜ overall scores (retuning the hyperparameter set with the highest overall score).

In step 216, a determination is made as to whether to terminate the hyperparameter optimization process as a whole. The final search iteration is denoted by T. In one embodiment, the value of T is predetermined. Thus, the process terminates after a fixed number of search iterations. In other embodiments, different termination condition(s) may be defined, meaning that T is variable.

If the termination condition(s) are not satisfied (t<T), the method proceeds to step 222, at which a new (intermediate) proxy model is fitted to the target dataset 101, using the candidate hyperparameter set selected in step 214 of the most recent search iteration (vₜ). Training of the new proxy comprises selecting the candidate hyperparameters in step 214 and fitting the new proxy to the target dataset D, which in turn involves learning parameters of the new proxy based on the target dataset using the selected hyperparameters. From here, the method returns to step 206, beginning a new search iteration based on the new proxy model determined at step 222, with t incrementing by one (t: =t+1). At this point, the proxy model trained in step 222 becomes the new current proxy model, modelₜ (noting that t has now incremented by one) denoted by reference sign 300-t in FIGS. 3 and 3A.

In the first extension, multiple proxy models are trained at step 222 based on the selected hyperparameters vₜ based on respective random seeds, resulting in multiple proxy models that form the basis of the next iteration.

The process continues iteratively in this manner, until eventually returning to returning to step 216 for the final time when the termination condition(s) are determined to be satisfied (thus reaching t=T). At this point, the optimized hyperparameter set 103 (V_{T}) has been obtained, and this is returned (step 218) as a final output of the hyperparameter optimisation process.

At step 220, the optimized hyperparameter set 103 is, in turn, used to train an optimized proxy model 105 (model_{T}). In the first extension, multiple firs proxy models are trained using v_{T}.

In a causal discovery application, the optimized proxy model(s) 105 provides an iteratively refined estimate of the causal properties (e.g. causal graph) of the target dataset D.

The implementation of FIG. 3 is further summarized in pseudocode in Algorithm 1 below.

Algorithm 1

```
D: target dataset
kt: number of proxy models generated per iteration
Functions:
  sample (M): sample dataset from model M.
  initialize( ): returns an initial set of hyperparameters.
  score(v, D): scoring function for a set of model hyperparameters v on
  dataset D.
  fit(v, D): function returning model fit using the hyperparameters v and
  dataset D.
v0 ← initialize( )
for t ← 1, · · · , T do
  for j ← 1, · · · , kt do
    model_tj ← fit(v_t-1, D)
    D\hat{ }_tj ← sample (model_tj)
    //Sample proxy dataset D\hat{ }_tj//
  end for
  vt ← argmax_v[ sum_j=1...kt ( score(fit(v, D\hat{ }_tj), D\hat{ }_tj ) ) ]
//Optimize hyperparameters on proxy datasets//
end for
return v_T
//The most refined hyperparameters//
```

To determine the ‘argmax’ in Algorithm 1, multiple candidate hyperparameters are evaluated and scored, as per FIGS. 2-3. This is not explicitly shown in Algorithm 1 and, as noted, different hyperparameter search processes may be used to generate the candidate hyperparameter searches with different algorithm implementations.

As noted, another embodiment incudes an acceptance condition at this stage. Rather than selecting vₜ directly based on the scores, all candidates v_{t,n} are ordered by their scores. Then, the algorithm iterates over the candidates in batches (subsets) of a fixed size (e.g. around ten candidates in one example). For each batch, training jobs are launched on the target dataset (to train a ‘candidate’ proxy model on the target dataset for each candidate in the batch). This embodiment thus involves training of multiple new (candidate) proxies at the end of each iteration. As part of this process, one or more batches of hyperparameters are selected based on their scores to enable different candidate proxies to be evaluated in the following manner. The batch is then re-ordered by log likelihood (for each candidate, this is the log likelihood of the target dataset with respect to the corresponding proxy model) in order to test whether to accept or reject the candidates in order. A candidate is accepted with a probability determined by its log likelihood (11) and the previously accepted log likelihood (prev_11) (that is, the log likelihood of the candidate selected in the previous iteration) and, once accepted, the corresponding candidate proxy model is selected for the next iteration. In one example, a candidate is accepted based on a score computed as exp(11−prev_11), which is interpreted as a probability of acceptance if less than 1. This quantity may be larger than 1 which happens when 11>prev_11, in which case the candidate is always accepted. With this second approach, the hyperparameter selection at the end of each iteration is still dependent on the scores, but unlike the first approach, it is not necessarily the highest scoring candidate that is selected.

The introduction of the acceptance condition addresses a convergence problem that can otherwise occur. Specifically, an issue can arise, in that the highest score in iteration t+1 might be lower than the highest score in iteration t, implying a drop in performance between iterations. The acceptance condition has been found to more reliability achieve an increase in performance across the multiple iterations.

The reordering means that, in a given iteration, the highest-scoring candidate will not necessarily be selected (it may or may not be, with a probability that is determined by the reordering and the log likelihoods), but that over multiple iterations the scores will tend to increase.

Algorithm 1 does not expressly cover the extension of FIG. 3A. In general, the sampled datasets may be independent (as in FIG. 3, with multiple proxies) or not, e.g. they may be replicated multiple times (as in FIG. 3A).

There are various ways of implementing the initialization function 110.

A first implementation starts with a manually constructed synthetic approximation which allows computing the objective (e.g. orientation f1 score). This may be written in pseudocode as:

synthetic(D): create a model (e.g. random model) for sampling synthetic datasets
matching metadata of D
k0>0: number of synthetic seed datasets.
D\tilde{ }_i ← sample(synthetic(D)) ∀ i = 1, · · · , k0
v0 ← argmax_v[ sum_i=1...k0 ( score(fit(v, D\tilde{ }_i), D\hat{ }_i ) ) ]

In the first implementation, the ‘synthetic’ function returns an initial model, model₀, from which v₀ is determined. This can be seen as iteration t=0 that is performed in the same way as subsequent iterations, but starting from e.g. a random initial proxy model.

A second implementation randomly or manually picks the initial set of hyperparameters v₀, and train a first model to act as the proxy.

A third implementation performs hyperparameter tuning on a different objective that can be computed without access to the underlying graph (such as tuning a log likelihood of the target data with respect to an initial proxy model, model₀). Existing hyperparameter tuning method may be used for this purpose.

In one causal application, the target dataset 101 may take the form of D={(Xᵢ, Tᵢ, Yᵢ)}, with i=1, . . . , N entities (e.g. physical systems), where Xᵢ denotes one or more covariates associated with entity i, Tᵢ denotes a treatment (e.g. a binary indicator of whether a treatment was applied to the entity), and Zᵢ denotes an outcome (e.g. a binary indicator of whether a particular outcome was obtained).

In another example, the target dataset 101 contains purely observational data, such as have real world outcomes with no particular controlled determined treatment or outcome, in which case D={Xᵢ}, with Tᵢ and Yᵢ effectively subsumed in Xᵢ.

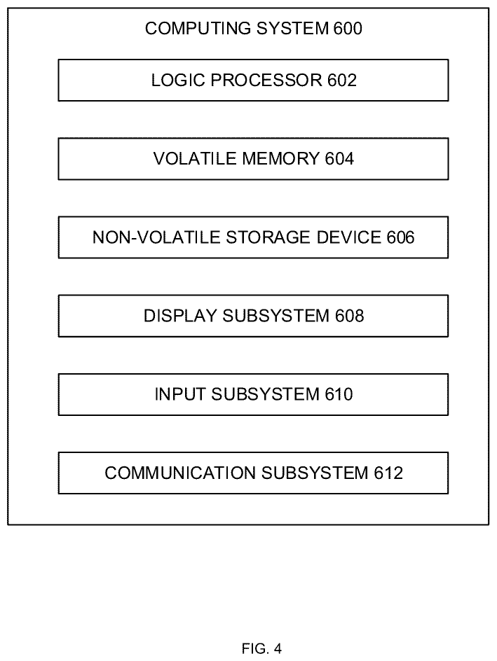

FIG. 4 schematically shows a non-limiting example of a computing system 600, such as a computing device or system of connected computing devices, that can enact one or more of the methods or processes described above, including the filtering of data and implementation of the structured knowledge base described above. Computing system 600 is shown in simplified form. Computing system 600 includes a logic processor 602, volatile memory 604, and a non-volatile storage device 606. Computing system 600 may optionally include a display subsystem 608, input subsystem 610, communication subsystem 612, and/or other components not shown in FIG. 6. Logic processor 602 comprises one or more physical (hardware) processors configured to carry out processing operations. For example, the logic processor 602 may be configured to execute instructions that are part of one or more applications, programs, routines, libraries, objects, components, data structures, or other logical constructs. The logic processor 602 may include one or more hardware processors configured to execute software instructions based on an instruction set architecture, such as a central processing unit (CPU), graphical processing unit (GPU) or other form of accelerator processor. Additionally or alternatively, the logic processor 602 may include a hardware processor(s)) in the form of a logic circuit or firmware device configured to execute hardware-implemented logic (programmable or non-programmable) or firmware instructions. Processor(s) of the logic processor 602 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor 602 may be virtualized and executed by remotely accessible, networked computing devices configured in a cloud-computing configuration. In such a case, these virtualized aspects are run on different physical logic processors of various different machines. Non-volatile storage device 606 includes one or more physical devices configured to hold instructions executable by the logic processor 602 to implement the methods and processes described herein. When such methods and processes are implemented, the state of non-volatile storage device 606 may be transformed—e.g., to hold different data. Non-volatile storage device 606 may include physical devices that are removable and/or built-in. Non-volatile storage device 606 may include optical memory (e g., CD, DVD, HD-DVD, Blu-Ray Disc, etc.), semiconductor memory (e g., ROM, EPROM, EEPROM, FLASH memory, etc.), and/or magnetic memory (e.g., hard-disk drive), or other mass storage device technology. Non-volatile storage device 606 may include nonvolatile, dynamic, static, read/write, read-only, sequential-access, location-addressable, file-addressable, and/or content-addressable devices. Volatile memory 604 may include one or more physical devices that include random access memory. Volatile memory 604 is typically utilized by logic processor 602 to temporarily store information during processing of software instructions. Aspects of logic processor 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example. The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via logic processor 602 executing instructions held by non-volatile storage device 606, using portions of volatile memory 604. Different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc. When included, display subsystem 608 may be used to present a visual representation of data held by non-volatile storage device 606. The visual representation may take the form of a graphical user interface (GUI). As the herein-described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with logic processor 602, volatile memory 604, and/or non-volatile storage device 606 in a shared enclosure, or such display devices may be peripheral display devices. When included, input subsystem 610 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor. When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 600 to send and/or receive messages to and/or from other devices via a network such as the internet. The term computer readable media as used herein may include computer storage media. Computer storage media may include volatile and non-volatile, removable and nonremovable media (e.g., volatile memory 604 or non-volatile storage 606) implemented in any method or technology for storage of information, such as computer readable instructions, data structures, or program modules. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by a computing device (e.g. the computing system 600 or a component device thereof). Computer storage media does not include a carrier wave or other propagated or modulated data signal. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct wired connection, and wireless media such as acoustic, radio frequency (RF), infrared, and other wireless media.

A first aspect herein provides a computer-implemented method, comprising: receiving a target dataset; determining an initial hyperparameter; training a first proxy model based on the target dataset and the initial hyperparameter, resulting in a trained first proxy model; sampling a first synthetic dataset based on the trained first proxy model; training a first evaluation model based on the first synthetic dataset and a first candidate hyperparameter, resulting in a trained first evaluation model; calculating a first matching score based on the trained first evaluation model and the trained first proxy model; and training a second proxy model based on the target dataset, the first candidate hyperparameter and the first matching score, resulting in a trained second proxy model.

The method may comprise training a further first proxy model based on the target dataset and the initial candidate hyperparameter; sampling a further first synthetic dataset based on the trained further first proxy model; training a further first evaluation model based on the first candidate hyperparameter and the further first synthetic dataset; calculating a further first matching score based on the trained further first evaluation model and the trained further first proxy model; computing a first aggregate score for the first candidate hyperparameter based on the first matching score and the further first matching score, wherein the second proxy model may be trained based on the first aggregate score.

The method may comprise training multiple first proxy models based on the target dataset and the initial candidate hyperparameter; sampling a first synthetic dataset based on each first proxy model, resulting in multiple first synthetic datasets; training a first evaluation model based on the first candidate hyperparameter and each first synthetic dataset, resulting in multiple first evaluation models dependent on the first candidate hyperparameter; calculating a first matching score between each first synthetic dataset and the first evaluation model trained thereon, resulting in multiple first matching scores relating to the first candidate hyperparameter; computing a first aggregate score for the first candidate hyperparameter based on the multiple first matching scores, wherein the first candidate hyperparameter is selected based on the first aggregate score.

The first proxy model may be trained based on the target dataset, the initial candidate hyperparameter, and a first random seed, wherein the further first proxy model is trained based on the target dataset, the initial candidate hyperparameter, and a further first random seed.

The method may comprise sampling a second synthetic dataset based on the second proxy model; training a second evaluation model based on the second synthetic dataset and a second candidate hyperparameter, resulting in a trained second evaluation model; calculating a second matching score based on the trained second evaluation model and the trained second proxy model; and training a third proxy model based on the target dataset, the second candidate hyperparameter and the second matching score, resulting in a trained third proxy model.

The method may comprise sampling a third synthetic dataset based on the trained third proxy model; training a third evaluation model based on the third synthetic dataset and a third candidate hyperparameter, resulting in a trained third evaluation model; calculating a third matching score based on the trained third evaluation model and the trained third proxy model; and training a fourth proxy model based on the target dataset, the third candidate hyperparameter and the third matching score, resulting in a trained fourth proxy model.

The first proxy model, the second proxy model and the first evaluation model may each have a generative neural network architecture.

The method may comprise determining using the trained first proxy model a first predicted target dataset property, wherein the first synthetic dataset may be sampled based on the first predicted target dataset property; and determining using the trained first evaluation model a first predicted synthetic dataset property, wherein the first matching score may be computed between the first predicted target dataset property and the first synthetic dataset property.

The first predicted target dataset property may comprise a first predicted target dataset causal property, wherein the first predicted synthetic dataset property may comprise a first predicted synthetic dataset causal property.

The first predicted target dataset causal property and the first predicted synthetic dataset causal property may be embodied in respective causal graphs sampled from the trained first proxy model and the trained first evaluation model respectively.

The first proxy model and the second proxy model may be causal models, the method may comprise: sampling a causal graph from the trained second proxy model or another trained proxy model derived from the trained second proxy model via additional sampling and training operations.

The method may comprise determining a treatment action based on the causal graph sampled from the trained second proxy model or the other proxy model; and performing the treatment action on a physical or logical system.

The first evaluation model may be one of multiple first evaluation models trained based on respective first candidate hyperparameters, resulting in multiple trained first evaluation models, wherein training the second proxy model based on the target dataset, the first candidate hyperparameter and the first matching score may comprise: selecting the first candidate hyperparameter from the respective first candidate hyperparameters based on respective first matching scores computed based on the multiple trained first evaluation models and the trained first proxy model, and fitting the second proxy model to the target dataset using the first candidate hyperparameter as selected based on based on respective first matching scores, resulting in the trained second proxy mode

Selecting the first candidate hyperparameter may comprise selecting a subset of the respective first candidate hyperparameters based on the respective first matching scores, the subset comprising the first candidate hyperparameter and an additional first candidate hyperparameter; fitting an additional second proxy model to the target dataset using the additional first candidate hyperparameter, resulting in a trained additional second proxy model; determining a first likelihood of the trained first proxy model with respect to the target dataset; determining a second likelihood of the trained second proxy model with respect to the target dataset; determining an additional second likelihood of the trained additional second proxy model with respect to the target dataset; and selecting the trained second proxy model from a set comprising the trained second proxy model and the trained additional second proxy model based on the first likelihood, the second likelihood and the additional second likelihood.

The method may comprise training multiple first evaluation models based on respective first candidate hyperparameters, the first candidate hyperparameter selected from the respective first candidate hyperparameters based on respective first matching scores computed between the multiple first evaluation models and the first synthetic dataset.

Selecting the first candidate hyperparameter may comprise: determining a subset of the respective first candidate hyperparameters based on the respective first matching scores; for each first candidate hyperparameter of the determined subset: training a candidate second proxy model based on the target dataset, and determining a likelihood of the candidate second proxy model with respect to the target dataset, resulting in multiple candidate second proxy models; and selecting the second proxy model from the multiple candidate second proxy models based on the likelihood and a likelihood of the first proxy model with respect to the target dataset.

The respective first candidate hyperparameters may be generated randomly.

The respective first candidate hyperparameters may be generated via a Bayesian search based on the respective first matching scores.

Determining the initial hyperparameter may comprise: generating an initial proxy model, sampling an initial synthetic dataset based on the initial proxy model, training multiple initial evaluation models based on the initial synthetic dataset and respective initial hyperparameters, computing an initial matching score based on each trained initial evaluation model and the initial proxy model, and selecting the initial candidate hyperparameter from the respective initial hyperparameters based on the initial matching score computed for each trained initial evaluation model.

The initial hyperparameter may be determined by generating an initial proxy model, sampling an initial synthetic dataset based on the initial proxy model, training an initial evaluation model based on the initial synthetic dataset and the initial hyperparameter, an initial matching score between the initial evaluation model and the initial synthetic dataset, and selecting the initial candidate hyperparameter based on the first matching score.

The initial hyperparameter may be randomly generated, or determined via tuning of a likelihood of the target dataset with respect to an initial proxy model.

The method may comprise, based on the trained second proxy model: tuning, adapting, modifying or replacing an industrial machine, performing a maintenance or repair action performed on a machine, generating image data, audio data, text or other content, or performing a security mitigation action.

A second aspect provides a computer system comprising: at least one memory configured to store computer-readable instructions; and at least one hardware processor coupled to the at least one memory, wherein the computer-readable instructions are configured to cause the at least one hardware processor to perform any above method.

A third aspect provides a computer-readable storage media embodying computer readable instructions, the computer-readable instructions configured upon execution on at least one hardware processor to cause the at least one hardware processor to perform any above method.

It will be appreciated that the above embodiments have been disclosed by way of example only. Other variants or use cases may become apparent to a person skilled in the art once given the disclosure herein. The scope of the present disclosure is not limited by the above-described embodiments, but only by the accompanying claims.

The invention claimed is:

1. A computer-implemented method, comprising:
receiving a target dataset;
determining an initial hyperparameter;
training a first proxy model based on the target dataset and the initial hyperparameter, resulting in a trained first proxy model;
sampling a first synthetic dataset based on the trained first proxy model;
training a first evaluation model based on the first synthetic dataset and a first candidate hyperparameter, resulting in a trained first evaluation model;
calculating a first matching score based on the trained first evaluation model and the trained first proxy model; and
training a second proxy model based on the target dataset, the first candidate hyperparameter and the first matching score, resulting in a trained second proxy model.

2. The method of claim 1, comprising:
training a further first proxy model based on the target dataset and the initial candidate hyperparameter, resulting in a trained further first proxy model;
sampling a further first synthetic dataset based on the trained further first proxy model;
training a further first evaluation model based on the first candidate hyperparameter and the further first synthetic dataset, resulting in a trained further first evaluation model;
calculating a further first matching score based on the trained further first evaluation model and the trained further first proxy model;
computing a first aggregate score for the first candidate hyperparameter based on the first matching score and the further first matching score, wherein the second proxy model is trained based on the first aggregate score.

3. The method of claim 2, wherein the first proxy model is trained based on the target dataset, the initial candidate hyperparameter, and a first random seed, wherein the further first proxy model is trained based on the target dataset, the initial candidate hyperparameter, and a further first random seed.

4. The method of claim 1, comprising:
sampling a second synthetic dataset based on the trained second proxy model;
training a second evaluation model based on the second synthetic dataset and a second candidate hyperparameter, resulting in a trained second evaluation model;
calculating a second matching score based on the trained second evaluation model and the trained second proxy model; and
training a third proxy model based on the target dataset, the second candidate hyperparameter and the second matching score, resulting in a trained third proxy model.

5. The method of claim 4, comprising:
sampling a third synthetic dataset based on the trained third proxy model;
training a third evaluation model based on the third synthetic dataset and a third candidate hyperparameter, resulting in a trained third evaluation model;
calculating a third matching score based on the trained third evaluation model and the trained third proxy model; and
training a fourth proxy model based on the target dataset, the third candidate hyperparameter and the third matching score, resulting in a trained fourth proxy model.

6. The method of claim 1, wherein the first proxy model, the second proxy model and the first evaluation model each have a generative neural network architecture.

7. The method of claim 1, comprising:
determining using the trained first proxy model a first predicted target dataset property, wherein the first synthetic dataset is sampled based on the first predicted target dataset property; and
determining using the trained first evaluation model a first predicted synthetic dataset property, wherein the first matching score is computed between the first predicted target dataset property and the first synthetic dataset property.

8. The method of claim 7, wherein the first predicted target dataset property comprises a first predicted target dataset causal property, wherein the first predicted synthetic dataset property comprises a first predicted synthetic dataset causal property.

9. The method of claim 8, wherein the first predicted target dataset causal property and the first predicted synthetic dataset causal property are embodied in respective causal graphs sampled from the trained first proxy model and the trained first evaluation model respectively.

10. The method of claim 1, wherein the first proxy model and the second proxy model are causal models, the method comprising:
sampling a causal graph from the trained second proxy model or another trained proxy model derived from the trained second proxy model via additional sampling and training operations.

11. The method of claim 10, comprising:
determining a treatment action based on the causal graph sampled from the trained second proxy model or the other proxy model; and
performing the treatment action on a physical or logical system.

12. The method of claim 1, comprising:
wherein the first evaluation model is one of multiple first evaluation models trained based on respective first candidate hyperparameters, resulting in multiple trained first evaluation models, wherein training the second proxy model based on the target dataset, the first candidate hyperparameter and the first matching score comprises:
selecting the first candidate hyperparameter from the respective first candidate hyperparameters based on respective first matching scores computed based on the multiple trained first evaluation models and the trained first proxy model, and
fitting the second proxy model to the target dataset using the first candidate hyperparameter as selected based on based on respective first matching scores, resulting in the trained second proxy model.

13. The method of claim 12, wherein selecting the first candidate hyperparameter comprises selecting a subset of the respective first candidate hyperparameters based on the respective first matching scores, the subset comprising the first candidate hyperparameter and an additional first candidate hyperparameter;
fitting an additional second proxy model to the target dataset using the additional first candidate hyperparameter, resulting in a trained additional second proxy model;
determining a first likelihood of the trained first proxy model with respect to the target dataset;
determining a second likelihood of the trained second proxy model with respect to the target dataset;
determining an additional second likelihood of the trained additional second proxy model with respect to the target dataset; and
selecting the trained second proxy model from a set comprising the trained second proxy model and the trained additional second proxy model based on the first likelihood, the second likelihood and the additional second likelihood.

14. The method of claim 12, wherein the respective first candidate hyperparameters are generated randomly.

15. The method of claim 12, wherein the respective first candidate hyperparameters are generated via a Bayesian search based on the respective first matching scores.

16. The method of claim 1, wherein determining the initial hyperparameter comprises:
generating an initial proxy model,
sampling an initial synthetic dataset based on the initial proxy model,
training multiple initial evaluation models based on the initial synthetic dataset and respective initial hyperparameters,
computing an initial matching score based on each trained initial evaluation model and the initial proxy model, and
selecting the initial candidate hyperparameter from the respective initial hyperparameters based on the initial matching score computed for each trained initial evaluation model.

17. The method of claim 1, wherein the respective initial hyperparameters are:
randomly generated, or
determined via tuning of a likelihood of the target dataset with respect to an initial proxy model.

18. The method of claim 1, comprising, based on the trained second proxy model:
tuning, adapting, modifying or replacing an industrial machine,
performing a maintenance or repair action performed on a machine,
generating image data, audio data, text or other content, or
performing a security mitigation action.

19. A computer system comprising:
at least one memory configured to store computer-readable instructions; and
at least one hardware processor coupled to the at least one memory, wherein the computer-readable instructions are configured to cause the at least one hardware processor to perform operations comprising:
receiving a target dataset;
determining an initial hyperparameter;
training a first proxy model based on the target dataset and the initial hyperparameter, resulting in a trained first proxy model;
sampling a first synthetic dataset based on the trained first proxy model;
training a first evaluation model based on the first synthetic dataset and a first candidate hyperparameter, resulting in a trained first evaluation model;
calculating a first matching score based on the trained first evaluation model and the trained first proxy model; and
training a second proxy model based on the target dataset, the first candidate hyperparameter and the first matching score, resulting in a trained second proxy model.

20. Computer-readable storage media embodying computer readable instructions, the computer-readable instructions configured upon execution on at least one hardware processor to cause the at least one hardware processor to perform operations comprising:
receiving a target dataset;
determining an initial hyperparameter;
training a first proxy model based on the target dataset and the initial hyperparameter, resulting in a trained first proxy model;
sampling a first synthetic dataset based on the trained first proxy model;
training a first evaluation model based on the first synthetic dataset and a first candidate hyperparameter, resulting in a trained first evaluation model;
calculating a first matching score based on the trained first evaluation model and the trained first proxy model; and
training a second proxy model based on the target dataset, the first candidate hyperparameter and the first matching score, resulting in a trained second proxy model.
